(19) United States
(12) Patent Application Publication
(10) Pub. No.: US 2017/0113577 A1
(43) Pub. Date: Apr. 27, 2017

(54) RESTRAINING ELEMENT

(71) Applicant: CYBEX GmbH, Bayreuth (DE)

(72) Inventor: Martin POS, Bayreuth (DE)

(21) Appl. No.: 15/308,513

(22) PCT Filed: May 5, 2014
(86) PCT No.: PCT/EP2014/059069

§ 371 Date: Dec. 6, 2016

(51) Int. Cl. B60N 2/28; B60R 22/10

(52) U.S. Cl. CPC B60N 2/2812; B60R 22/105; B60N 2/2839; B60N 2002/2818

(57) ABSTRACT

The invention relates to a restraining element (1) for restraining a child (25), comprising a vehicle belt system which comprises a diagonal belt portion (7) and a horizontal belt portion (17), in particular for use with a child seat (21). The restraining element (1) extends approximately transversally above the upper leg of a child. (25) sitting on a seat surface (29). The restraining element is characterized in that the restraining element has a first belt guide (5) for the diagonal belt portion (7), and the horizontal belt portion (17) interacts with a second belt guide (15) such that the horizontal belt section (17) extends away directly over the upper leg of the child (25).

The invention relates to a restraining element for restraining a child, comprising a vehicle belt system according to the preamble of claim 1.

A restraining element of the kind mentioned above is known for example from EP 206 11 59 A1. Such restraining elements are provided to keep a child especially sitting in a child seat in the seat in the case of an accident or strong braking. Impact shield systems can be used on the passenger seat or back seat and interact with (conventional) three-point belts. The waist belt section of a three-point belt usually extends in a transversely extending groove-shaped recess in the impact shield or it rests on the exterior side of the impact shield.

Such restraining elements with a child seat can generally be used with or without the backrest and with or without side rests. The impact shield can rest on the thighs of the child and/or on the child seat. The impact shield can also alternatively be supported on a vehicle seat. Especially in the case of bigger children, restraining elements are used even without the associated child seat. In this case, the (already older) child is seated directly on the vehicle seat and the restraining element is fastened to said seat or the vehicle.

In the case of hard braking or even a frontal impact of the vehicle, the torso of the child is pushed onto the surface (inside surface) of the impact shield. It is therefore often provided with a foam or padded insert in order to avoid injuries.

When the restraining element itself is fixed to the child seat, said child seat can be fixed to a vehicle seat or the vehicle. For this purpose, the seat is often fixed to a pedestal in the prior art, which is provided with an ISOFIX anchoring which can be fixed to ISOFIX fastening points on the seat, namely to cross bolts.

It is a fundamental problem in the restraining elements as known from the prior art that the child, in the case of an accident for example, covers a comparatively great distance until it is decelerated by the restraining element. In the most extreme of cases, the head of the child can hit a front seat or fixtures in the vehicle.

It is therefore the object of the present invention to provide a restraining element for a vehicle, especially for connection with a child seat, which holds the child in an especially secure and constructively simple way in the child seat or on the vehicle seat, especially in the case of a rollover of a vehicle.

This object achieved by a restraining element with the features of claim 1.

The restraining element is used for holding a child with a belt system of a vehicle having a diagonal belt section and a horizontal belt section, and is especially formed for use with a child seat, wherein the restraining element extends approximately transversally above the thighs of a child sitting on a seating surface. The restraining element comprises a first belt guide for the diagonal belt section and the horizontal belt section interacts with a second belt guide, such that the horizontal belt section extends directly over the thighs of the child. The second belt guide can be arranged either on the restraining element or a seat, especially on a child seat interacting with the restraining element.

It is therefore a fundamental concept of the invention that the horizontal belt section of a three-point belt system, i.e. the lap belt, is in direct contact with the child. It is thus ensured that the child is held in an especially secure way in the seat in case of an accident of the vehicle, especially in combination with a rollover. The diagonal belt section of the belt is tensioned during a forward movement of the torso of the child. The forwardly moved diagonal belt section tightens up the horizontal belt section via a belt deflection in the connecting region of the belt on the vehicle. As a result, the horizontal belt section (lap belt) is pulled downwardly in the direction of the seating surface. Accordingly, a tightening of the diagonal belt section is produced via the belt deflection when the horizontal belt section, during a rollover of the vehicle, is moved by a movement of the child in the direction of the vehicle roof liner. The child is thus fixed in any case in a secure manner on the seating surface or on the back support surface, in that the horizontal belt section rests directly on the child and belt tensioning thus acts directly on the child. In summary, secure fixing of the pelvis of the child is produced by the invention when the torso exerts a tension on the diagonal belt section or the thighs exert a tension on the horizontal belt section. The restraining element according to the present invention thus ensures increased safety for the child in the case of an accident of the vehicle and especially in the case of a rollover.

The first and/or the second belt guide can be formed as slot-shaped openings. The first belt guide can be arranged on the front side of the restraining element. The second belt guide can comprise two guide sections which are respectively arranged on both sides of the restraining element, between which the horizontal guide section can freely be guided. The two guide sections of the second belt guide can preferably be provided as lateral recesses in the restraining element. The second belt section guide or its guide sections are preferably arranged at a (vertical) distance from the first belt guide on a bottom side of the restraining element. It is thus ensured that the horizontal belt section, in the state of use of the restraining element, rests directly on the child and especially on its thighs.

The first belt guide and the second belt guide are preferably oriented with respect to each other in such a way that a guidance of the diagonal belt section and the horizontal belt section is produced which is oriented substantially perpendicularly with respect to each other. The best possible restraining function of the restraining element is thus produced. The second belt guide, which is preferably formed in a slot-shaped manner, is preferably oriented substantially parallel to the thighs of the child in the state of use of the restraining element. As a result, the horizontal belt section also extends substantially parallel to the thighs of the child, so that an optimal restraining effect is achieved by the belt in the case of an accident. The second belt guide for accommodating the horizontal belt section is preferably open towards the front side of the restraining element. The horizontal belt section can thus come into engagement with the restraining element and especially with the first belt guide in an especially simple way.

A first belt guide is especially advantageous which extends between the two side surfaces of the restraining element and has a substantially curved progression. An optimal guidance of the diagonal belt section, which is provided to be diagonal or oblique to the highest possible extent, can be achieved in this manner of positioning of the restraining element both on the left and right side in the motor vehicle. The restraining effect of the diagonal belt section can thus be improved even further.

It is especially advantageous if the restraining element is adjustably mounted relative to the seating surface, especially to the seating surface of a child seat. The restraining element is preferably provided at an angle which rises from the rear to the front. The restraining element can further be adjusted continuously or alternatively in steps.

In order to reduce the risk of injury to the child to the highest possible extent in the case of an accident, the restraining element can comprise a cushion facing the chest of the child, which defines a chest support region. Furthermore, the restraining element can comprise a hollow body with an approximately U-shaped cross-section, which hollow body is open in a direction to the front in the mounted position and defines the slot-shaped first belt guide.

Preferably, the bottom side of the restraining element encloses an acute angle in an advantageous further development of the invention, i.e. an angle <90°, with a back support surface associated with the restraining element. The angle is especially approximately 60° to 85°, preferably 70° to 85°. The angle in the mounted state of the restraining element advantageously approximately corresponds to the inclination of a seating surface associated with the restraining element. The seating surface therefore also encloses an acute angle with the associated back support surface. The seating surface and the bottom side of the restraining element are oriented in this embodiment in the state of use of the restraining element substantially parallel with respect to each other.

The invention will be explained below in closer detail by reference to the drawings, wherein;

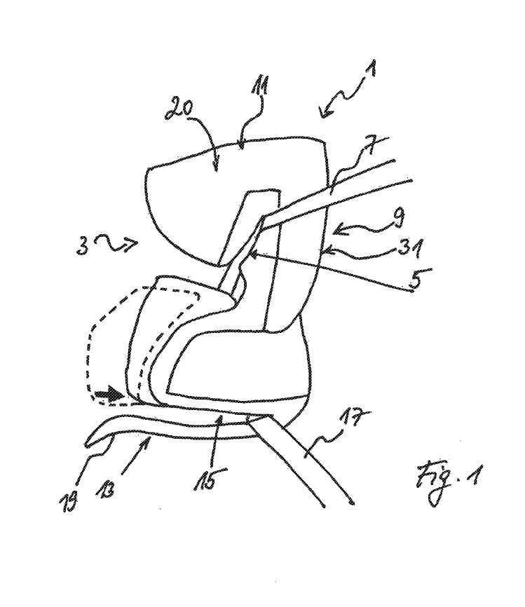

FIG. 1 shows a side view of the restraining element according to the present invention;

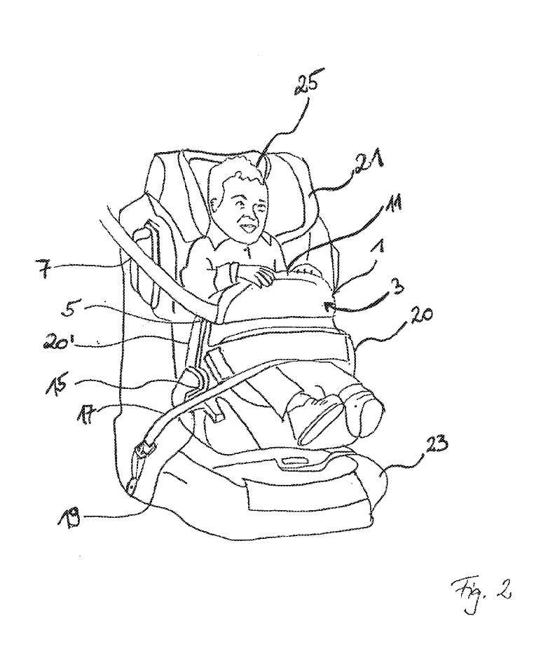

FIG. 2 shows a perspective view of a restraining element according to the present invention which interacts with a child seat, and

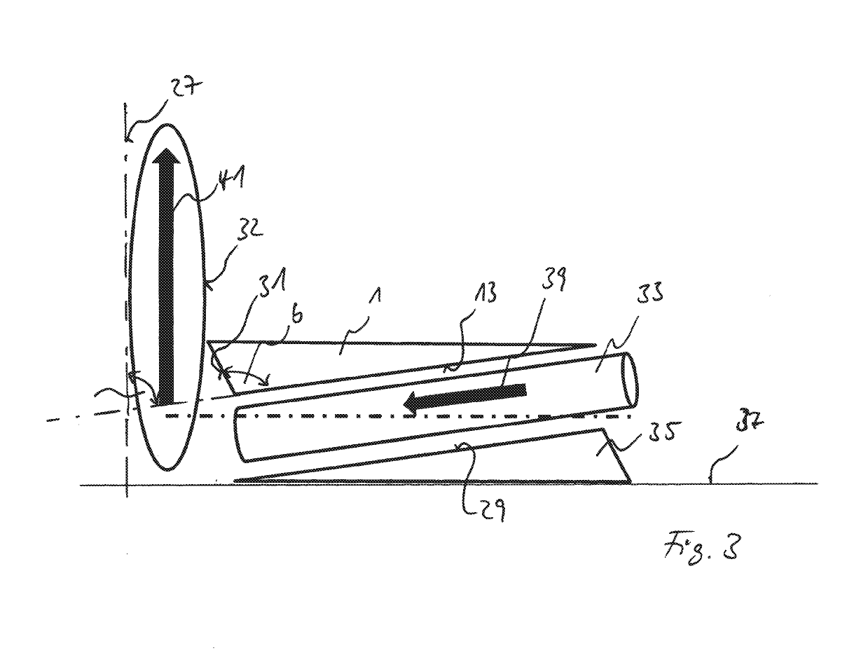

FIG. 3 shows a schematic side view of the restraining element according to an advantageous further development of the invention with an associated seating surface,

FIG. 1 shows a schematic side view of a restraining element 1 according to the invention. The restraining element 1 preferably comprises a hollow or foam body with a substantially U-shaped cross-section, which at its front side 3, i.e. the side facing away from the child, is open and accommodates a first belt guide 5 for accommodating a diagonal belt section 7, i.e. the chest belt, of a three-point belt system and guides it therein.

As is shown in FIG. 1, the first belt guide 5 is formed in the manner of a slot, so that the diagonal belt section 7 can be inserted easily into the first belt guide 5 on the one hand and it is prevented from being twisted therein to the highest possible extent on the other hand.

The illustration further shows that a backside 9 of the restraining element 1, i.e. the side of the restraining element 1 facing the child, and especially also an upper side 11, which forms an armrest surface for the child, are formed in a padded manner.

In the region of a bottom side 13 which faces the thighs of a child in the state of use of the restraining element 1, the restraining element 1 comprises a second belt guide 15. The second belt guide 15 is used for accommodating a horizontal belt section 17, i.e. a lap belt, of a three-point belt system. The second belt guide 15 need not necessarily be arranged directly on the restraining element 1. It can rather be considered to arrange the second belt guide 15 on a child seat or the like associated with the restraining element 1.

The second belt guide 15 is also formed in the present embodiment in a substantially slot-shaped manner, so that the horizontal belt section 17 can be inserted easily into the slot-shaped second belt guide, but should not be twisted therein.

In the present case, the second belt guide 15 comprises two guide sections which are situated opposite each other and arranged at a distance from each other, of which FIG. 1 only shows one guide section 19. The guide section 19 is formed integrally with the remaining restraining element 1 and extends along the bottom side 13 of the restraining element 1 in the region of a side surface 20 of the restraining element 1. The second belt guide 15 or the guide section 19 is open toward the front side 3 of the restraining element 1, so that a user of the restraining element 1 can easily insert the horizontal belt section 17.

FIG. 1 further illustrates that the orientation of the slot-shaped first and second belt guides 5 and 15 is such that the surfaces of the horizontal and diagonal belt sections 7, 17 are disposed substantially perpendicularly on each other. This provides an optimally adjusted guidance of the belt relative to the seating position of the child.

FIG. 2 shows a perspective schematic illustration of the restraining element 1 in the state of use. In the example shown in FIG. 2, the restraining element 1 interacts with a child seat 21 which is positioned on a car seat 23 of a vehicle, especially a motor vehicle. The restraining element 1 further interacts with a conventional three-point belt system of a vehicle, which comprises the diagonal belt section 7 (chest belt section) and the horizontal belt section 17 (lap belt section).

The restraining element 1 can be placed on the child seat 21 and can be fastened thereto by means of the belt system. The child seat 21 can also be fastened to the car seat 23 by means of the belt system. It can also be provided alternatively that the restraining element 1 is adjustably fastened to the child seat 21. In particular, the restraining element 1 or the child seat 21 can comprise respective connecting elements such as latching elements, which allow adjustability of the restraining element 1, especially in the horizontal and/or in the vertical direction. The restraining element 1 can thus be adjusted in this manner to children of different size.

FIG. 2 further illustrates that for fastening the restraining element 1 the diagonal belt section 7 is guided through the first belt guide 5, while the horizontal belt section 17 is guided through the second belt guide 15. Since the second belt guide 15 for accommodating the horizontal belt section 17 is situated in the region of the bottom side 13 of the restraining element 1 and thus close to the seating surface, the horizontal belt section 17 can be positioned in such a way that it is in direct contact with the child 25 in the state of use of the restraining element 1 and rests especially on its thighs.

The two belt guides 5, 15 are arranged at a suitable vertical distance from each other, In particular, the first belt guide 5 is advantageously arranged close to the upper side 11 of the restraining element 1, whereas the second belt guide is associated with the bottom side 13 of the restraining element 1.

Since the second belt guide 15 comprises two mutually separated guide sections 19 in the illustrated embodiment of the invention, which guide sections are each arranged opposite each other on both sides 20, 20′ of the restraining element 1, the horizontal belt section 17 extends substantially freely between the two guide sections 19 in the state of use, so that the horizontal belt section 17 can rest on the thighs of the child 25.

FIG. 3 further shows an advantageous further development of the invention, which contributes to increased safety for the child. In the illustrated embodiment, the bottom side 13 of the restraining element 1 encloses in its state of use an acute angle with a back support surface 27 associated with the restraining element 1 or a chest surface 32 of the child. The angle a can especially be between 60° and 85°, especially between 70° and 85°. The back support surface 27 can especially concern the backrest of a vehicle seat or the backrest of a child seat.

The illustration further shows that the angle a approximately corresponds to the inclination of a seating surface 29 associated with the restraining element 1 in the mounted state of the restraining element 1. The seating surface 29 thus preferably also encloses an acute angle a with the associated back support surface 27. The seating surface 29 and the bottom side 13 of the restraining element 1 are oriented in this embodiment in a substantially parallel manner with respect to each other in the state of use of the restraining element 1 and the thighs 33 of the child are arranged in between.

Furthermore, a chest support surface 31 on the bottom side 9 of the restraining element 1 of the child can enclose an obtuse angle b>90° with the bottom side 13 of the restraining element 1, so that the chest support surface 31 is formed in an inclined manner towards the chest surface 32 of the child 25 in the state of use of the restraining element 1. Depending on the size of the child, the wedge-shaped seat 35 can further be formed in a shorter or longer way and can thus be adjusted to the length of the thighs 33 of the child. The angles a and b, i.e. the inclination of the seating surface 29 and the restraining element 1, can also vary depending on the size of the child.

Unlike conventional child securing devices for vehicles in which the seating unit 35 and the impact shield 1 are oriented parallel to the floor 37, the seating unit 35 and the impact shield 1 or the seating surface 29 and the bottom side 13 are inclined in accordance with the invention in the direction of the child. This constricts the “slippage channel” between the seating unit 35 and the impact shield 1 because the popliteal spaces of the child are situated at a higher altitude than the opposite end of the thighs 33 and the portion of the restraining element 1 facing the body is situated at the lower altitude than the portion facing away from the body of the child. As a result, the child can only be pulled with an increased input of force from the seat in the case of a vehicle rollover, as indicated by the arrows 39 and 41.

It is advantageously ensured by the present invention that in the case of an accident and a resulting application of force on the torso of the child 25, the horizontal belt section 17 is tensioned and thus a direct fixing of the child on the child seat 21 or the car seat 23 is produced. The restraining element 1 according to the present invention thus ensures a considerably lower risk of injury to a child in the case of an accident.

### LIST OF REFERENCE NUMERALS

1 Restraining element
3 Front side
5 First belt guide
7 Diagonal belt section
9 Rear side
11 Upper side
13 Bottom side
15 Second belt guide
17 Horizontal belt section
19 Guide section
20 Side surface
21 Child seat
23 Car seat
25 Child
27 Back support surface
29 Seating surface
31 Chest support surface
32 Chest surface
33 Thigh
35 Seating (unit)
37 Floor
39 Arrow
41 Arrow
a Acute angle
b Obtuse angle

1. A restraining element for holding a child with a belt system of a vehicle comprising a diagonal belt section and a horizontal belt section, configured for use with a child seat, wherein the restraining element extends approximately transversally above the thighs of a child sitting on a seating surface, wherein the restraining element comprises a first belt guide for the diagonal belt section, and the horizontal belt section interacts with a second belt guide, such that the horizontal belt section extends directly over the thighs of the child.

2. A restraining element according to claim 1, wherein the second belt guide is arranged on the restraining element or on a seat.

3. A restraining element according to claim 1, wherein the first or the second belt guide is formed as a slot-shaped opening.

4. A restraining element according to claim 1, wherein the first belt guide is arranged on a front side of the restraining element.

5. A restraining element according to claim 1, wherein the second belt guide comprises two guide sections respectively arranged on both sides of the restraining element, between which the horizontal belt section can be freely guided.

6. A restraining element according to claim 5, wherein the second belt guide or its guide sections are arranged at a distance from the first belt guide on a bottom side of the restraining element.

7. A restraining element according to claim 1, wherein the first belt guide and the second belt guide produce a guidance of the diagonal belt section and the horizontal belt section which is oriented substantially perpendicularly with respect to each other.

8. A restraining element according to claim 1, wherein the second belt guide, in the state of use of the restraining element, is oriented substantially parallel to the thighs of the child.

9. A restraining element according to claim 1, wherein the second belt guide is open at a front side of the restraining element.

10. A restraining element according to claim 1, wherein the first belt guide, in the state of use of the restraining element, is oriented substantially parallel to the chest of the child.

11. A restraining element according to claim 1, wherein the first belt guide has a substantially curved progression between the two side surfaces of the restraining element.

12. A restraining element according to claim 1, wherein the restraining element is adjustably mounted relative to the seating surface and at an angle increasing from the rear to the front.

13. A restraining element according to claim 1, wherein the restraining element is continuously adjustable or alternatively in steps.

14. A restraining element according to claim 1, wherein the restraining element comprises a cushion facing the chest of a child, which cushion defines a chest support region.

15. A restraining element according to claim 1, wherein the restraining element comprises a hollow body with an approximately U-shaped cross-section, which in the mounted position is open in a forward direction and defines the first belt guide.

16. A restraining element according to claim 1, wherein the bottom side of the restraining element encloses an acute angle with a back support surface.

17. A restraining element according to claim 16, wherein the acute angle, in the mounted state of the restraining element, approximately corresponds to the inclination of the seating surface associated with the restraining element.
